(19) United States
(12) Patent Application Publication
(10) Pub. No.: US 2008/0109742 A1
(43) Pub. Date: May 8, 2008

(54) Method, program and system for manipulating images to perform unpredictable actions

(76) Inventor: Jason Ian VanAnden, Brooklyn, NY (US)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 11/975,452

(22) Filed: Oct. 19, 2007

Related U.S. Application Data
(60) Provisional application No. 60/855,522, filed on Oct. 31, 2006.

(51) Int. Cl. G06F 3/048

(52) U.S. Cl. 715/765

(57) ABSTRACT

Musical sounds are unpredictably generated to create unique musical compositions by manually manipulating images on a graphical user interface.

### CROSS REFERENCE TO RELATED APPLICATION

This application claims the benefit of U.S. provisional patent application Ser. No. 60/855,522, filed Oct. 31, 2006.

### BACKGROUND OF THE INVENTION

1. Field of the Invention

The present invention generally relates to a method of, and a system and a program for, manipulating images on a graphical user interface (GUI) to perform unpredictable actions and, more particularly, to unpredictably generating sounds to create unique musical compositions.

2. Description of the Related Art

Composing music is typically a linear exercise. One note predictably follows another along a time line. In an orchestral piece, multiple notes are played simultaneously, but all the notes are still laid out in advance in a fixed pattern. Such musical compositions are often exhilarating but, for some musicians and listeners, a more improvisational style is desired. Jazz artists specialize in improvising musical pieces but, even in such cases, there are repetitive elements known as phrasing, especially over multiple performances, that tend to detract from a more life-like, more random, non-linear, musical experience.

### SUMMARY OF THE INVENTION

One feature of this invention resides in a method of, and a system and a program for, manipulating images on a graphical user interface to enable a processor to perform unpredictable actions, for example, unpredictably generating sounds that constitute a unique musical composition. The processor is advantageously an integrated circuit chip, but could be any analog or digital electronic circuit. The chip is mounted in any apparatus, such as a computer, either stand-alone or networked, a portable terminal, a telephone, a music player, a digital assistant, etc.

A plurality of shapes is visually presented on a display, such as a computer monitor screen, or like interface. The shapes are manually arranged in a workspace on the display so that at least two, and preferably more, of the shapes overlap each other. In the preferred embodiments, the shapes are circles and, when two circles overlap, the common area resembles a convex lens.

Each shape is associated with an action, for example, generating or playing a sound, e.g., musical notes, songs, or sound effects. Each shape has an activated state in which the associated sound is generated, and a non-activated state in which the associated sound is not generated. Preferably, the activated and non-activated states are visually indicated by different appearances on the screen. For example, the non-activated state may have no or a certain color filled within the circle, and the activated state may have a different fill color. The colors may even change on subsequent activations, thereby creating a light show to accompany the sound show. Alternatively, the activated and non-activated states may be visually indicated by changing the configuration of the circle to some other configuration, e.g., an ellipse.

Once the shapes are arranged in the workspace, the sounds are unpredictably sequentially generated based on a probability created by the overlapping circles. The probability is increased based on the extent of the common area. If, for example, there are three intersecting circles, then after the sound from a first circle is played, then the sound from either the second or the third circle may be played next. It is not known in advance whether the second or the third circle will be played next. In a preferred embodiment, the probability that a particular circle will be played is greater if that particular circle shares a greater common area with the first circle than some other circle.

Thus, the method comprises the steps of creating a topology of the images on a display or like interface; associating the images with the actions, e.g., sounds, to be executed by the processor; manually selecting at least one of the images to activate the processor to execute the action associated with the selected image; and activating the processor to execute actions associated with other of the images by automatically selecting the other images in an order of probability based on the topology of the images. The creating, associating and manually selecting steps may be performed by a user and stored for subsequent use. The activating step may be performed by the same or another user. In this manner, a first user can compose a composition, and another user can either enjoy or edit the composition. The resulting musical and visual composition changes from one performance to the next. A dynamic listening and visual experience is therefore achieved.

This invention is not intended to be limited to the playing of musical sounds or generation of different shapes and colors. Each shape can be associated not with generating a sound, but with something else, for example, illuminating a light, or executing a command to a robot capable of moving, making facial expressions, and the like. Rather than playing sounds or illuminating lights, different commands can be executed, and the robot can dynamically and unpredictably move about a venue, change facial expressions, and the like.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a screenshot on a display interface depicting activation of a first circle in a group of circles to generate a sound according to this invention;

FIG. 2 is analogous to FIG. 1, and shows activation of a second circle;

FIG. 3 is analogous to FIG. 1, and shows activation of a third circle;

FIG. 4 is a flow chart depicting the method according to this invention; and

FIG. 5 is a perspective view of a computer system for executing the method and program according to this invention.

### DETAILED DESCRIPTION OF THE PREFERRED EMBODIMENTS

Reference numeral 10 in the figures identifies a workspace, preferably rectangular, on a computer monitor screen 30 (see FIG. 5) or like interface in which a plurality of shapes, preferably circles 12, 14, 16, 18, is arranged. Circles 12, 18 overlap each other and bound a common area 20 resembling a convex lens. Circle 12 also overlaps circles 14, 16 and bounds common areas 22, 24. The circles are of different sizes. The common areas are of different sizes and may be symmetrical or asymmetrical.

The particular arrangement or topography of the circles within the workspace 10 is selectable by a user or creator. The user may select the size and placement of any circle. Circles do not need to overlap. The shapes need not be circular. The workspace need not be rectangular.

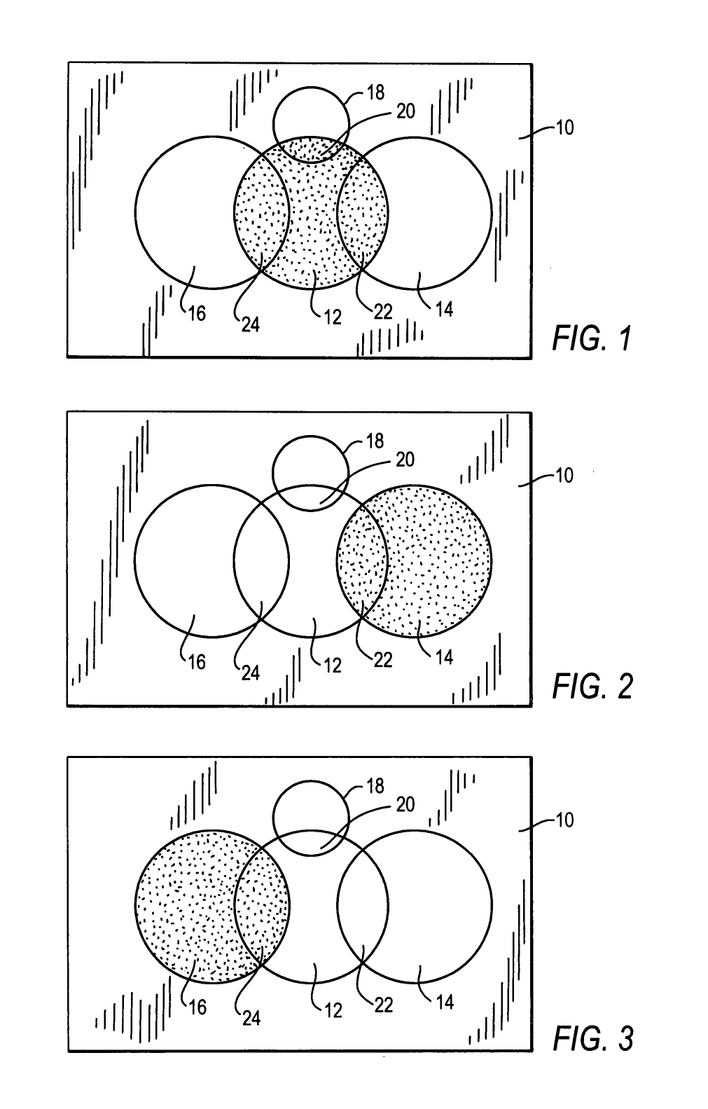

Each circle has an inactive and an active state, as described below. In FIG. 1, circle 12 is activated, as indicated by its being filled in with a certain color. In FIGS. 2-3, filled-in circles 14, 16 are respectively activated. The circles that are not filled in with a color are inactive.

The monitor screen 30 is operatively connected to a programmed processor in a computer 32 (see FIG. 5) or like apparatus. Software for creating the shapes and the workspace and for controlling their operation, as described below, is preferably written in the Java programming language, version 1.4.2. Java is compatible with many different computer operating systems.

Each circle is operatively associated with a unique sound file, for example, one of the notes on a musical scale, or a song, or a sound effect. If a circle is selected and made active, for example by being touched on the screen 30 by the user, or by being clicked upon by a mouse 34 or other input device, or by depressing a key on a keyboard 36, then the associated sound file is executed, and a sound is generated for a certain time period from speakers 38 connected to the computer. After the time period has elapsed, the selected circle returns to the inactive state and, depending upon the topography, another circle is activated, and another sound is generated. As described below, the choice of which circle is next activated depends on a weighted probability factor, which is increased or decreased by the extent of the common areas 20, 22, 24. The extent of the common areas is selectable by the user.

The workspace is measured in pixels on the monitor screen 30. For example, the rectangular workspace can be represented by coordinates of its upper left and bottom right corners. Preferably, a width of 300 pixels and a height of 200 pixels are used. Each circle can be represented by the coordinates of its center point and its radius. The background color of the workspace, as well as the color or absence of color of each circle in its active or inactive states, is defined by a respective color attribute, which may change upon subsequent activations.

In order to create a topography in the first instance, or to modify an existing topography, the user may create, duplicate, or remove circles, as well as change the properties of the circles and the workspace by using a pointer such as the mouse 34, stylus or touch screen 30 in combination with key presses on the keyboard 36. The mouse and keyboard are used to describe the functionality in the following actions:

1. Select Circle: User moves mouse cursor over a circle, presses left mouse button down and holds. Circle changes visual state to indicate that it is now selected.

2. Move Circle: User selects circle (see Select Circle) and moves the mouse cursor. The circle's coordinates change based upon the coordinates of the mouse cursor position until the user lifts off of the mouse button.

3. Duplicate Circle: User selects circle (see Select Circle) and then clicks the period key on the keyboard. A copy of the selected circle appears in the workspace.

4. Delete Circle: User presses comma key while a circle is selected. Circle disappears from workspace.

5. Change Circle Size: User selects a circle (see Select Circle) and continues to press mouse button without moving it. If the user clicks above the center point of the circle, the radius will get larger; otherwise, it will shrink smaller. This will occur in timed increments until the user lifts of the mouse button.

6. Activate/Deactivate a Circle: User double-clicks on a circle with mouse. If the current circle is active, it becomes inactive. If the current circle is in an inactive state, it becomes active.

7. Save Composition: Click on the F5 key to save the current topography.

8. Quit Application: The F6 key immediately quits the application.

After the topography has been created or modified, it is stored in a memory 40 of the processor 32 and displayed on the monitor screen 30. The user may now execute the software, and the circles will be successively activated, and the sounds will be successively generated. By way of example, circles 12, 14, 16 in FIGS. 1-3 are successively activated with different fill colors.

After circle 12 is activated, any one of the circles 14, 16, 18 may be the next to be activated. The choice is based on weighted probability factors, as described below.

For each circle, a function is called to calculate the distance (in pixels) of intersection between it and each of the other circles. This distance is determined by calculating the difference of the sum of their radii and the distance of their center points. If the distance between the circles is less than the sum of their radii, then they intersect. The difference is stored as a variable to be used to calculate the weighted probability.

A timing loop is started to repeat at regular (currently 100 millisecond) intervals. With each pass of the loop, any user input is checked, the circles are redrawn and the status of each circle is checked.

Upon completing playing its sound sample, the activated circle probabilistically determines another circle to activate, as follows:

a. If the activated circle does not intersect with any other circle, then the activated circle reactivates itself. This has the effect of playing the sounds as a loop.

b. If at least one circle intersects another, then each circle in the topography is assigned a unique identifying number, also known as a pointer. For each pixel of the distance calculated above, the unique number or pointer of the intersecting circle is added to a group, i.e., an array list. By way of numerical example, if circle 14 overlapped circle 12 by a distance of eight pixels, and if circle 16 overlapped circle 12 by a distance of five pixels, then the group or list would be populated with thirteen numbers or pointers, five of which would uniquely identify circle 16, and eight of which would uniquely identify circle 14.

c. After circle 12 has been activated, a random number generator chooses a number or pointer from the group. It is more likely that the number or pointer randomly selected will uniquely identify circle 14, because there are more numbers or pointers in the group uniquely identifying circle 14. This random number identifies the next circle 14 to be activated. Thus, the circle having the greatest common area with the activated circle is typically, but not necessarily, the next to be activated. There is always a chance that the random number generator will select a number or pointer that uniquely identifies circle 16 despite the fact that circle 16 has a smaller common area with circle 12.

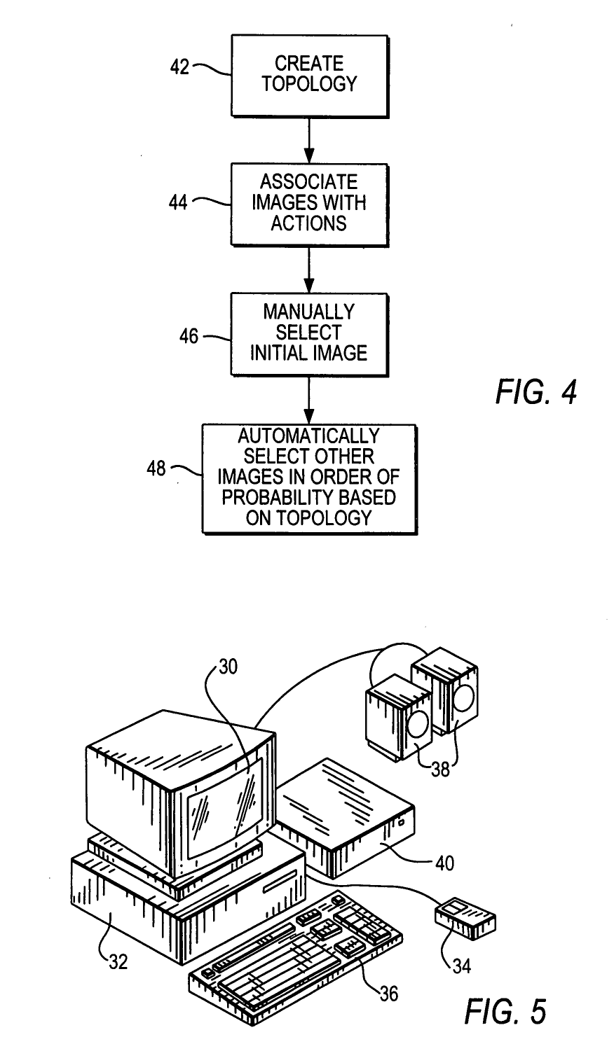

As shown in the flow chart of FIG. 4, the method of manipulating the images to perform unpredictable actions executed by the programmed processor 32, comprises the steps of creating a topology of the images (step 42) on the display 30; associating the images with the actions (step 44) to be executed by the processor; manually selecting at least one of the images (step 46) to activate the processor to execute the action associated with the selected image; and activating the processor to execute actions associated with other of the images by automatically selecting the other images in an order of probability based on the topology of the images (step 48). The creating (step 42), associating (step 44) and manually selecting (step 46) steps may be performed by a user and stored for subsequent use. The activating step (step 48) may be performed by the same or another user. In this manner, a first user can compose a composition, and another user can either enjoy or edit the composition.

It will be understood that each of the elements described above, or two or more together, also may find a useful application in other types of constructions differing from the types described above. For example, this invention can be implemented on a host server on the Internet, and a user with Internet access can operate the program, either alone or collaboratively with others. This invention can also be implemented on a music player in which case the songs on a playlist can be played in the probabilistic order described herein.

While the invention has been illustrated and described as a method of, a program for, and a system for, manipulating images to perform unpredictable actions, it is not intended to be limited to the details shown, since various modifications and structural changes may be made without departing in any way from the spirit of the present invention. For example, the user need not select just one image, but can select multiple images, for execution. The selected image(s) can be stored for subsequent playback. The subsequent user need not select any image, but can merely allow the stored image(s) to be executed.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

What is claimed as new and desired to be protected by Letters Patent is set forth in the appended claims.

1. A method of manipulating images to perform unpredictable actions executed by a programmed processor, comprising the steps of:
creating a topology of images on a display;
associating the images with the actions to be executed by the processor;
manually selecting at least one of the images to activate the processor to execute the action associated with the selected image; and
activating the processor to execute actions associated with other of the images by automatically selecting the other images in an order of probability based on the topology of the images.

2. The method of claim 1, wherein the creating step is performed by overlapping at least two of the images to bound a common area with each other; and wherein the activating step is performed by determining an extent of the common area, and by basing the order of probability at least partially upon the extent of the common area.

3. The method of claim 2, wherein the activating step is performed by determining the extent of each common area between the selected image and each other image overlapping the selected image, by populating a list of the overlapping images based upon the extent of each common area, and by randomly selecting one of the overlapping images in the list as the next image whose associated action is to be next executed by the processor.

4. The method of claim 3, wherein the greater the extent of the common area, the greater the probability that the next image from the list will be randomly selected.

5. The method of claim 1, wherein the creating step is performed by creating the images as circular shapes having centers and radii, and by manually selecting a coordinate position for each center on the display, and by manually adjusting a size for each radius.

6. The method of claim 1, and visually indicating when each image has been selected.

7. The method of claim 6, wherein the creating step is performed by creating the images as circular outlines having interiors, and wherein the visually indicating step is performed by filling each interior with a background color.

8. The method of claim 1, and storing the topology in a memory of the processor when each image has been selected.

9. The method of claim 1, wherein the associating step is performed by associating the images with sounds as the actions to be executed by the processor.

10. A program stored in a processor for manipulating images and for executing unpredictable actions by the processor, the program enabling performance of the steps of:
creating a topology of images on a display;
associating the images with the actions to be executed by the processor;
manually selecting at least one of the images to activate the processor to execute the action associated with the selected image; and
activating the processor to execute actions associated with other of the images by automatically selecting the other images in an order of probability based on the topology of the images.

11. A programmed processor system for manipulating images to perform unpredictable actions, comprising the steps of:
means. for creating a topology of images on a display;
means for associating the images with the actions to be executed by the processor;
means for manually selecting at least one of the images to activate the processor to execute the action associated with the selected image; and
means for activating the processor to execute actions associated with other of the images by automatically selecting the other images in an order of probability based on the topology of the images.

12. The system of claim 11, wherein the creating means is operative for overlapping at least two of the images to bound a common area with each other; and wherein the activating means is operative for determining an extent of the common area, and for basing the order of probability at least partially upon the extent of the common area.

13. The system of claim 12, wherein the activating means is operative for determining the extent of each common area between the selected image and each other image overlapping the selected image, for populating a list of the overlapping images based upon the extent of each common area, and for randomly selecting one of the overlapping images in the list as the next image whose associated action is to be next executed by the processor.

14. The system of claim 13, wherein the greater the extent of the common area, the greater the probability that the next image from the list will be randomly selected.

15. The system of claim 11, wherein the creating means is operative for creating the images as circular shapes having centers and radii, and for manually selecting a coordinate position for each center on the display, and for manually adjusting a size for each radius.

16. The system of claim 11, and means for visually indicating when each image has been selected.

17. The system of claim 16, wherein the creating means is operative for creating the images as circular outlines having interiors, and wherein the visually indicating means is operative for filling each interior with a background color.

18. The system of claim 11, and a memory for storing the topology when each image has been selected.

19. The system of claim 11, wherein the associating means is operative for associating the images with sounds as the actions to be executed by the processor.
